(19) United States
(12) Patent Application Publication
(10) Pub. No.: US 2011/0041431 A1
(43) Pub. Date: Feb. 24, 2011

(54) APPARATUS AND METHOD FOR INSTALLING WINDOWS AND DOORS IN TIMBER FRAME CONSTRUCTION

(76) Inventor: George . McKenna, Dundee (GB)

Correspondence Address: WINSTEAD PC, P.O. BOX 50784, DALLAS, TX, 75201, US

(21) Appl. No.: 12/745,211

(22) PCT Filed: Oct. 23, 2008
(86) PCT No.: PCT/GB08/03577

§ 371 Date: Oct. 20, 2010

(30) Foreign Application Priority Data
Nov. 28, 2007 (GB) 0723283.8

(51) Int. Cl. E06B 1/02; E06B 1/60

(52) U.S. Cl. 52/204.1; 52/745.15

(57) ABSTRACT

A timber frame panel (10) comprising a plurality of framing members (14, 16) which form a perimeter of a window opening (12), wherein at least one of the framing members (14, 16) has guidance means (40) provided thereon, and wherein the timber frame panel (10) includes a window unit 30 slidably attached to said at least one of the framing members (14, 16) by said guidance means (40) such that the entire window unit (30) can move from a first position substantially within the timber frame panel (10) to a second position in which part of the window unit (30) projects beyond the timber frame panel (10).

The invention relates to a method of installing windows and doors in a timber framed kit building, and to kits and frames used in timber frame kit building. The invention also relates to an apparatus which is used to install windows and doors in a timber framed kit building.

It is known to use timber framed kits to construct buildings. A large percentage of new build houses in the UK are constructed using timber frame kits. Such a kit comprises a number of timber frame panels which are manufactured under factory conditions, transported to site and then lifted into position and connected together. An external skin, such as cladding of brickwork or blockwork, is then constructed outside the timber frame, while an internal finish, such as plasterboard, is applied to the inside of the timber frame. Openings are formed in the timber frame panels to allow the subsequent installation on site of doors and windows. The doors and windows are delivered to site as door units and window units which include frames and cills, and must be lifted into position in the openings, where they are then fixed.

Until the doors and windows are installed, the building is not weathertight and so many internal finishing tasks cannot be carried out until the doors and windows are fitted. The external skin can only be constructed up to the cill level of the opening until the door unit or window unit is installed. Since the door and window units are delivered separately, substantial delays can occur. A further problem is that the door and window units can be very heavy. Health and safety regulations put a limit on the weight of units which can be lifted by hand, so many door and window units require the use of a crane or other lifting device for installation within the timber frame panel.

As used in this specification, the term timber frame panel includes any manufactured panel used in the construction of a building, at least partially manufactured from structural timber and designed to be connected with other panels in the construction of a building. As used in this specification, the term timber frame panel kit includes any group of such panels which are designed to be assembled as part of a building. As used in this specification the terms window, window unit and window frame include doors, door units and door frames, as well as combined window/doors, window/door units and window/door frames.

It is an object of the present invention to overcome one or more of the aforementioned problems.

According to a first aspect of the present invention there is provided a timber frame panel comprising a plurality of framing members which form a perimeter of a window opening,

wherein at least one of the framing members has guidance means provided thereon,

and wherein the timber frame panel includes a window unit slidably attached to said at least one of the framing members by said guidance means such that the window unit can move from a first position substantially within the timber frame panel to a second position in which part of the window unit projects beyond the timber frame panel.

At least two of said framing members have guidance means provided thereon, and the window unit may be slidably attached to said at least two framing members by said guidance means. In one embodiment there may be four framing members, and guidance means may be provided at spaced intervals on all four framing members. The four framing members may include two horizontal framing members and two vertical framing members.

The guidance means may be adapted to guide the window unit to move perpendicularly to the pane of the timber frame panel. If the guidance means includes a track, then the track may be fixed perpendicularly to the pane of the timber frame panel provided in the form of tracks

The guidance means may comprise a track member and a sliding member which engages with said track.

The track member may be attached to the framing member and the sliding member may be attached to the window unit. However the function may be reversed so that the sliding member may be attached to the framing member and the track member may be attached to the window unit

In one embodiment the sliding member includes an arm which projects beyond the window unit and which is adapted to be fixed to the framing member when the window unit is in its second position. It may also be fixed to the framing member when the window unit is in its first position.

The track member may include a face plate secured to a surface of the framing member parallel to the plane of the timber frame panel. The face plate helps to fix the track member to the framing member, and may be fixed to an internal or external surface of the framing member.

The arm of the sliding member may be adapted to slide within a slotted track formed in the track member.

The timber frame panel may further include first fixing means to fix the window unit in its first position. The first fixing means may comprise coincident apertures in the track member and sliding member and a fastener passing through the apertures into the framing member. One of the apertures may be a slot, to allow for fine adjustment in position.

The timber frame panel may further include second fixing means to fix the window unit in its second position. The second fixing means may comprise coincident apertures in the track member and sliding member and a fastener passing through the apertures into the framing member. The same aperture in the sliding member may serve as both first and second fixing means. One of the apertures may be a slot, to allow for fine adjustment in position.

The track member and sliding member may include mutually engaging detent means to prevent their relative movement beyond a position in which the window unit is in its second position. The detent means may comprise a constriction in the track member and a shoulder in the sliding member adapted to bear against the constriction when the window unit is in its second position.

The sliding member may be attached to the window unit by lugs which engage with a slot in the window unit.

According to a second aspect of the present invention there is provided a timber frame panel kit comprising a plurality of timber frame panels, at least one panel being a panel according to the first aspect.

According to a third aspect of the present invention there is provided a method of constructing a building using a timber frame panel comprising the steps of:

manufacturing a timber frame panel which includes a plurality of framing members which form a perimeter of a window opening,
installing a window unit in the window opening such that the window unit is in a first position substantially within the timber frame panel,
transporting the timber frame panel to a construction site,
assembling the timber frame panel with other panels, and
sliding the window unit from the first position to a second position in which part of the window unit projects beyond an external face of the timber frame panel.

Before sliding the window unit at least one first fixing means is released to allow relative movement of the window unit and timber frame panel, and after sliding the window unit at least one second fixing means is secured to fix the window unit relative to the timber frame panel. The first and second fixing means may use the same fastener, such as a screw, in conjunction with various apertures in a fixing bracket.

The method may include the further steps of:

constructing an external skin separated from the external face of the timber panel by a cavity, and
sealing the window unit in its second position to the external skin.

In the first and second positions of the window unit, the plane of the window unit may remain substantially parallel to the plane of the timber frame panel.

The timber frame panel may be a timber frame panel according to the first aspect.

According to a fourth aspect of the present invention there is provided a bracket for use in fixing a window unit in a timber frame panel, the bracket comprising:

a track member adapted for attachment to a framing member, and
a sliding member having an arm slidingly engaged with the track member in a longitudinal sliding direction and having an engagement means at one end of the arm for attachment to a window unit,
wherein the track member includes a face plate extending substantially perpendicular to the sliding direction and adapted to be secured to the framing member.

The track member may include a slotted track having a longitudinal slot, and the arm of the sliding member may be adapted to slide within the slotted track, the engagement means extending through the longitudinal slot.

The track member and sliding member may include first fixing means comprising apertures which are coincident in a first position when the arm nests with the track member, and second fixing means comprising apertures which are coincident in a second position when the engagement means and a portion of the arm project beyond the track member.

The track member and sliding member may include mutually engaging detent means to prevent their relative movement beyond a position in which the window unit is in its second position. The detent means may comprise a constriction in the track member and a shoulder in the sliding member adapted to bear against the constriction and prevent further sliding of the sliding member relative to the track member.

The engagement means may comprise lugs adapted to engage with a slot in a window unit, or at least one fastener adapted to engage with a window unit through an aperture in the sliding member.

The invention will now be described with reference to the drawings in which:

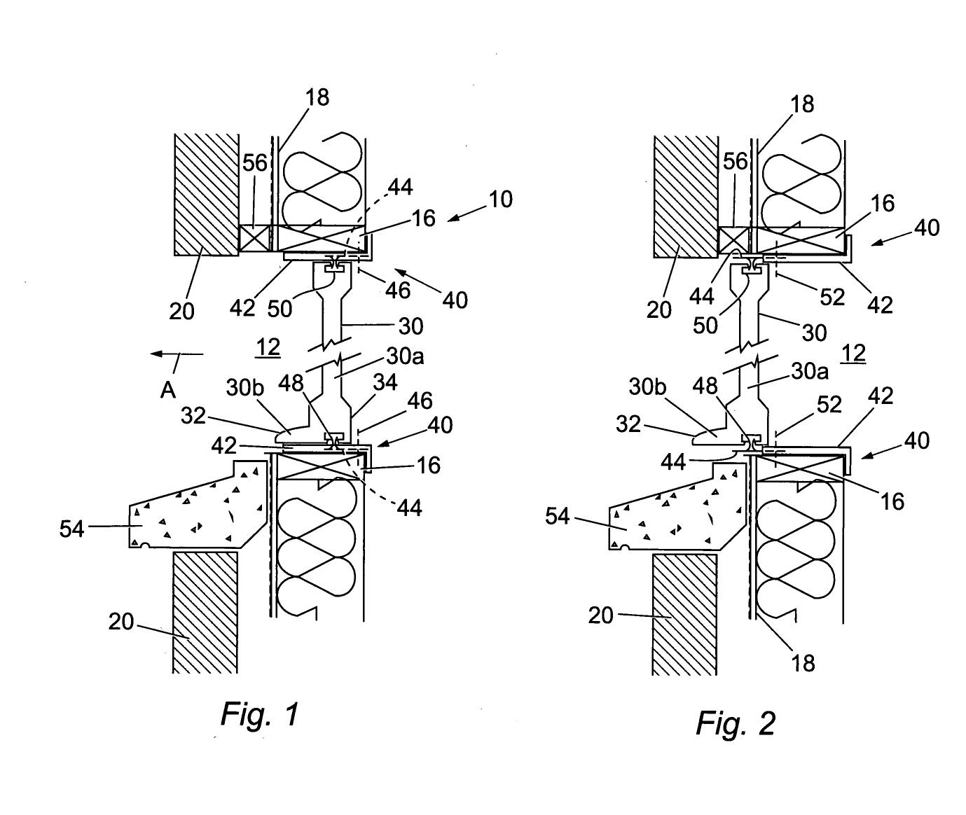

FIG. 1 shows a vertical cross section through part of a timber frame panel according to the invention with a window unit in a first position;

FIG. 2 shows a vertical cross section through the timber frame panel of FIG. 1 with the window unit in a second position;

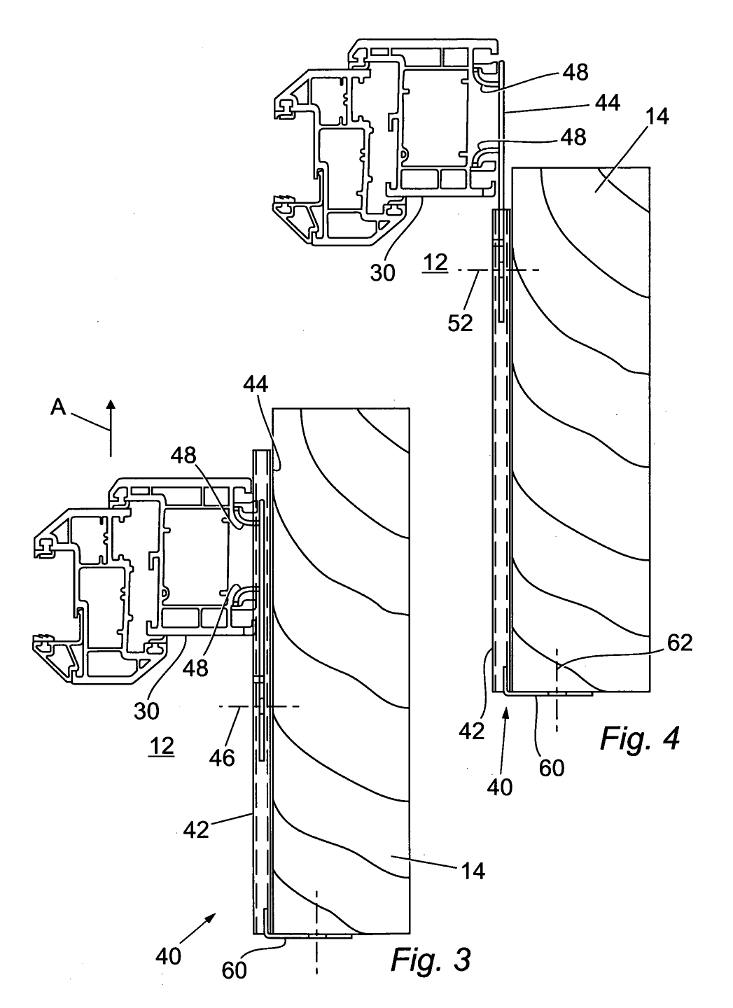

FIG. 3 shows a horizontal section through a vertical framing member of another timber frame panel according to the invention with a window unit in a first position;

FIG. 4 shows a horizontal section through the vertical framing member of FIG. 3 with the window unit in a second position;

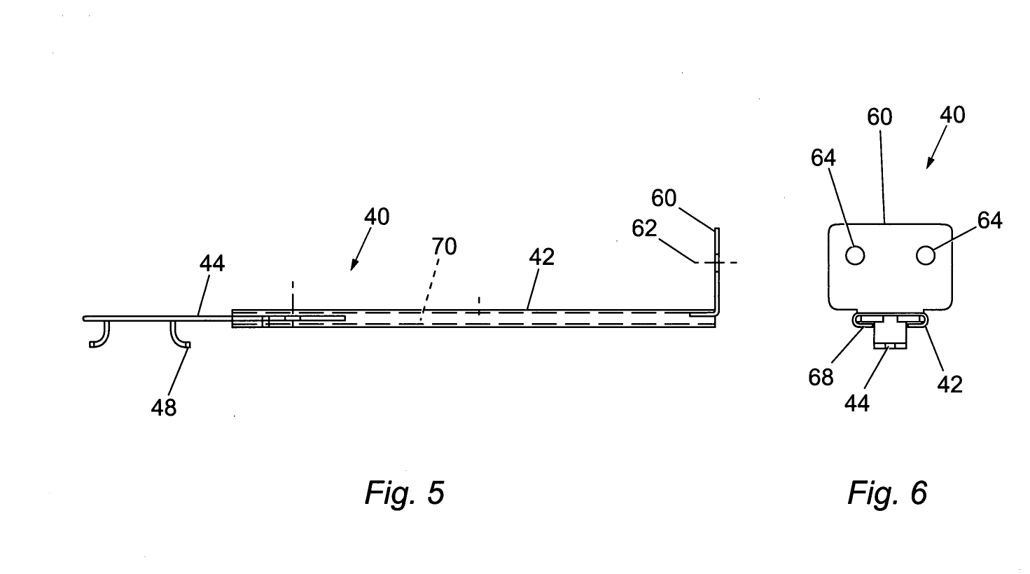

FIGS. 5 and 6 show a side view and end view respectively of a fixing bracket according to the invention;

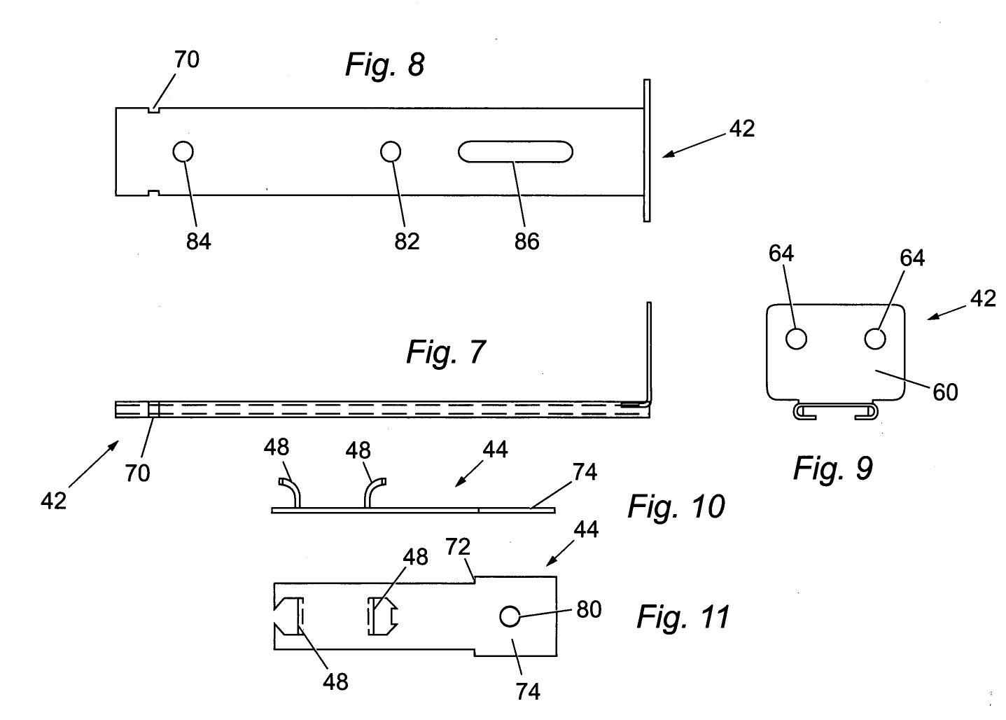

FIGS. 7, 8 and 9 show a side view, plan view and end view respectively of a track member of the fixing bracket of FIG. 5;

FIGS. 10 and 11 show a side view and plan view respectively of a sliding member of the fixing bracket of FIG. 5;

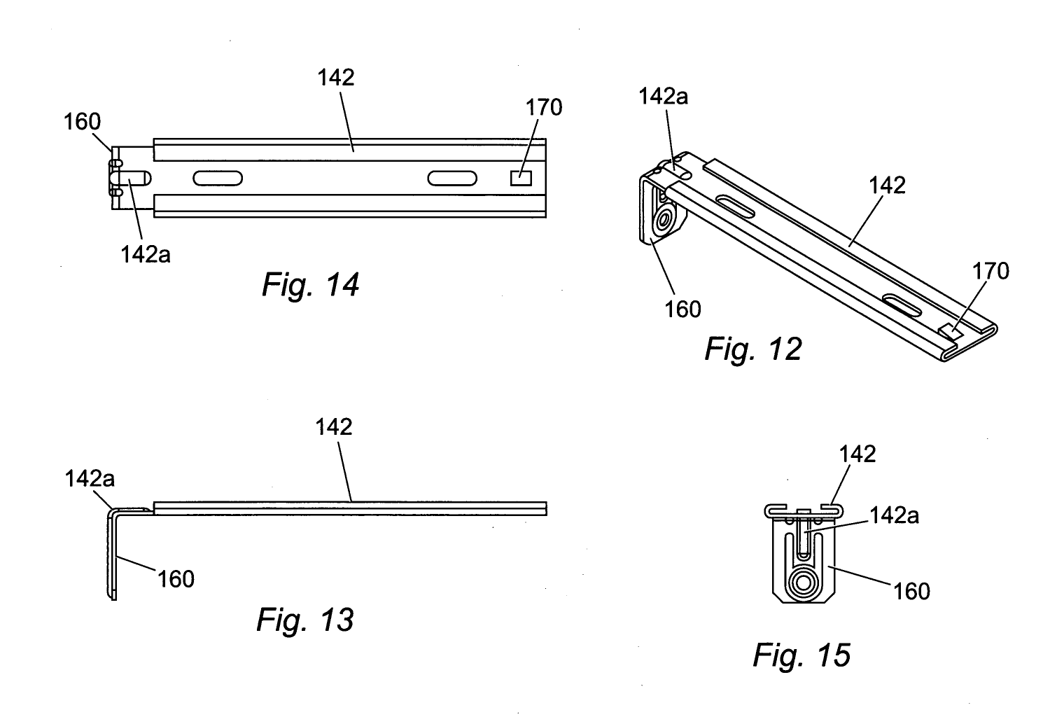

FIGS. 12, 13, 14 and 15 show perspective, side, top and end views, respectively, of a track member of a fixing bracket according to an alternative embodiment of the invention; and

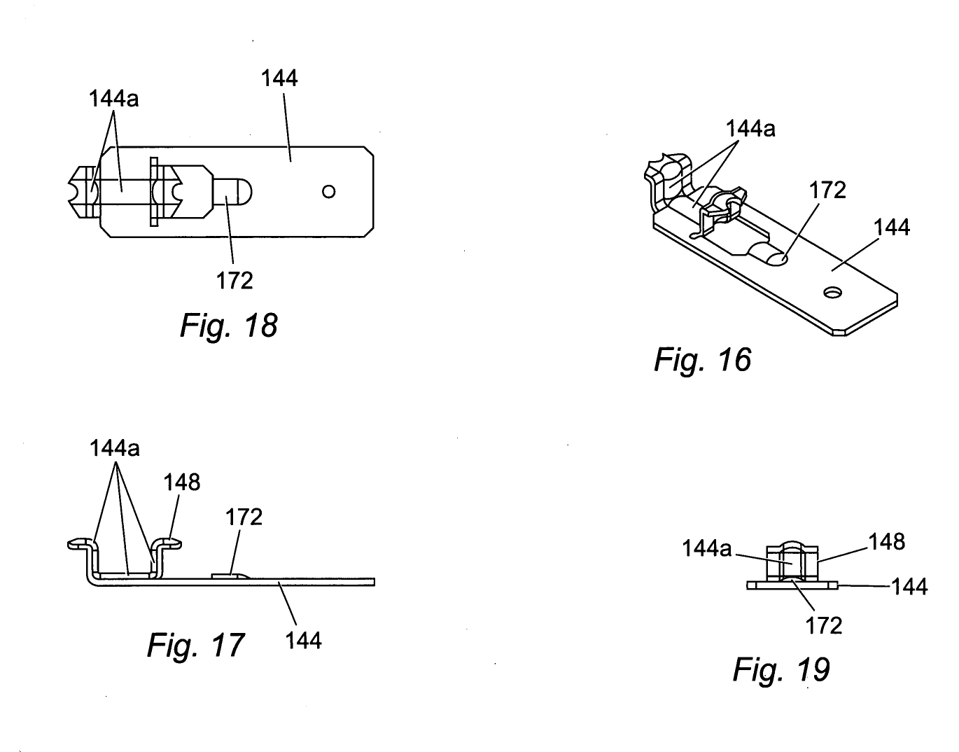

FIGS. 16, 17, 18 and 19 show a perspective, side, top and end view, respectively, of a sliding member of a fixing bracket according to an alternative embodiment of the invention.

Referring to FIGS. 1 and 2 there is shown a partial section through a timber frame panel 10 according to the present invention. The timber frame panel 10 includes a number of structural timber members connected together to form a frame. The structural members may include bottom rails, top rails, intermediate rails and vertical studs, as is known in the art. The panel 10 also includes an opening 12 surrounded by framing members, including vertical framing members 14 (shown in FIGS. 3 and 4) and horizontal framing members 16. The panel 10 may also include sheathing 18, for example of plywood. The panel 10 forms an inner skin of a cavity wall construction, and the outer skin 20 is constructed after the kit of panels 10 has been assembled.

Traditionally window units are delivered separately to the construction site and installed in the openings 12 after the kit of panels 10 has been assembled. However, in the present invention the window unit 30 is supplied as part of the timber frame panel 10, and the panel is delivered to the construction site with the window unit 30 already installed in the first position shown in FIG. 1. In this position the entire depth of the window unit 30, measured from the front 32 to the back 34 of the window unit, is contained within the depth of the timber frame panel 10. This ensures that the panels of the kit may be transported and stacked adjacent to each other without risk of damaging the window units.

The window unit 30 comprises a frame 30a and one or more panes of glass (not shown). The frame 30a of the window unit 30 also forms a cill 30b, however it should be appreciated that the frame 30a may not necessarily include a cill 30b. Although not illustrated, it should be appreciated that the window unit 30 may additionally comprise one or more window sashes, one or more transoms (horizontal window pane dividing members) and one or more mullions (vertical window pane dividing members).

The window unit 30 is secured in the first position by a number of guidance means 40. In this example, the guidance means are fixing brackets 40, which comprise a track member 42 fixed to the framing member 16, and a sliding member 44 which is free to slide relative to the track member 42 when not restrained by a fixing means 46. The fixing means in this example is a screw 46, which passes through coincident apertures in the track member 42 and sliding member 44 and engages with the framing member 16. This stops the sliding member 44 moving relative to the track member 42.

The sliding member 44 includes an engagement means, which fixes the sliding member 44 to the window unit 30. In the illustrated embodiment, the engagement means is a pair of lugs 48, which engage in a slot 50 in the window unit. This method of attachment is particularly suitable for UPVC window units, which can be formed with extruded slots 50. However, any suitable means of engagement may be used. If the window units are of timber construction, then the sliding member 44 may be attached to the window unit 30 by screws or other fixings.

The window unit 30 is fixed in the position shown in FIG. 1 at the factory where the timber frame panel 10 is assembled. The sliding member 44 is fixed to the window unit 30 by the engagement means 48, and to the track member 42 by the fixing 46, so that the window unit 30 cannot move relative to the timber frame unit 10. If required, additional transport wedges can be fitted between the window unit 30 and the framing members 14, 16 of the timber frame panel 10, to provide additional stability during transportation of the kit of timber frame panels 10. Once the panel 10 has been assembled in the position shown in FIG. 1, then the transport wedges (not shown) may be removed.

FIG. 2 shows the window unit 30 in its second or final fix position. The entire window unit 30 (i.e. the window frame 30a, pane of glass and cill 30b) is moved from the first position shown in FIG. 1 by sliding. First the fixing 46 is removed from each fixing bracket 40, then the entire window unit 30 is pushed from the inside or pulled from the outside so that it slides in the direction of arrow A. Detent means 70, 72, shown in FIGS. 7 to 11, prevent the sliding member 44 from sliding beyond a position corresponding to the final fix position of the window unit 30. A fixing means 52, which may be the screw 46 removed when the window unit 30 is in the first position shown in FIG. 1, is passed through the fixing apertures in the track member 42 and sliding member 44 and driven into the framing member 16 to hold the window unit 30 in its second position. In this position, the front 32 of the window unit extends outside the opening 12 in the timber frame panel 10, so that part of the window unit 30 projects beyond the panel 10.

The window unit 30 can be moved to its final fix position very easily, and without skilled labour, since the fixing brackets 40 control the position to which the window unit 30 is moved. Construction of the outer skin 20 of blockwork or brickwork can then follow quickly after assembly of the kit of timber frame panels 10. Appropriate finishing components, such as a precast concrete cill 54 and timber cavity barrier 56, together with appropriate damp-proof courses (not shown), may be fitted. The apertures in the track member 42 and sliding member 44 may be formed as slots, to allow fine adjustment of the position of the window unit 30 in both the first and second positions. An appropriate sealant (not shown) may be used to seal around the window unit 30 in its second position.

Fixing brackets 40 may be provided on some or all of the framing members 16, 18, which surround the opening 12. More than one fixing bracket 40 may be provided on each framing member, depending on the size of the window unit 30. The number and spacing of the fixing brackets is determined by the requirements of the appropriate building codes and the window unit manufacturers. With reference to FIGS. 3 and 4 there is shown a fixing bracket 40 fixed to a vertical framing member 14. The track member 42 has an end plate 60 which is fixed to the framing member 14 by an appropriate fastener, for example a screw 62. FIG. 3 shows the window unit 30 in the first position, in which the timber frame panel 10 is transported to site as part of the timber frame panel kit. Once the kit has been erected on site, the window unit 30 is slid in the direction of arrow A to the second position, shown in FIG. 4. Other components are identical to those illustrated in FIGS. 1 and 2 and are not described further.

The fixing bracket 40 is shown in more detail in FIGS. 5 and 6. The track member 44 is illustrated in FIGS. 7 to 9, and the sliding member 42 is shown in FIGS. 10 and 11. The end plate 60 is formed perpendicular to the slotted track 68. In the illustrated example the end plate 60 has two fixing apertures 64 for fixing the bracket 40 to the framing member 14, 16 by means of suitable fasteners 62. In FIG. 5 the sliding member 44 is shown at its second, fully extended position, in which the shoulder 72 bears against the constriction 70 in the slotted track 68. The arm 74 of the sliding member 44 engages in the slotted track 68, so that the sliding member 44 is free to move to the right from the position shown in FIG. 5. A pair of lugs 48 extend from the sliding member 44, as best seen in FIGS. 10 and 11, to engage with the window unit 30. However, it is to be understood that the lugs are shown by way of example only. Any suitable engaging means may be used to connect the sliding member 44 to the window unit 30. The engaging means may include, but is not limited to, fasteners such as screws, bolts or rivets, adhesive or any mutually engaging components.

Although in the illustrated embodiment the slotted track 68 is provided on the member 42 fixed to the framing member 14, 16, while the member 44 fixed to the window unit 30 slides in the track 68, the function may be reversed, so that the track is provided on the member 44 fixed to the window unit 30, and the arm which engages with the track 68 is provided on the member 42 fixed to the framing member 14, 16. The slotted track 68 may be replaced by any other suitable guidance means.

In the illustrated embodiment, the end plate 60 is shown secured to the inside of framing members 14, 16. However, the end plate 60 may be fixed instead to the outside surface of the framing members 14, 16, or may be omitted altogether, and the track member 42 may instead be secured to the framing member 14, 16 by any other means, such as fasteners provided within the slotted track.

In the illustrated embodiment, the sliding member 44 has a single aperture 80, which in the first position is aligned with the first aperture 82 in the track member 42. Alternatively, or in addition, the track member may be provided with an elongated slot 86, which allows a choice of position for the window unit 30 in the first position. When the window unit 30 is moved to its second position, the aperture 80 in the sliding member 44 is coincident with the aperture 84 in the track member 42, so that a fastener 52 may be used to fix the sliding member 44 relative to the track member 42, thereby fixing the window unit 30 in its second position. In this position, the shoulder 72 bears against the constriction 70 in the slotted track 68. The aperture 84 in the track member 42 may be replaced by a slot to allow fine adjustment of the position of the window unit 30 in its second position.

FIGS. 12 to 19 illustrate an alternative fixing bracket 140. The fixing bracket 140 is similar in construction to the fixing bracket 40 illustrated in FIGS. 5 to 11, the major difference being the configuration of the detent means, which prevent the sliding member from sliding beyond the position corresponding to the final fix position of the window unit 30, and the end plate 160 of the track member 142 and the engagement means 148 of the sliding member 144.

The detent means 170, 172 are illustrated in FIGS. 12 to 15 and 16 to 19, respectively. The detent means 170 of the track member 142 (illustrated in FIGS. 12 to 15) is a wedge-shaped member having an inclined surface which provides an abutment for engaging with the detent means 172 of the sliding member 144. The detent means 172 of the sliding member 144 (illustrated in FIGS. 16 to 19) is a semi-cylindrical shaped member formed, for example, by indenting the opposite surface of the sliding member 144 on which the detent means 172 is formed. The detent means 170, 172 function in a similar manner as described above to prevent the sliding member 144 (and window unit 30) from sliding beyond the position corresponding to the final fix position.

As best seen in FIGS. 12, 13, 16 and 17, the end plate 160 of the track member 142 and engagement means 148 of the sliding member 144 include “rib” portions 142a and 144a (an example of indented strengthening portions). The rib portions 142a and 144a are semi-cylindrical shaped members formed, for example, by indenting the surfaces of the track member 142 and sliding member 144. The rib portions 142a and 144a increase the strength of the end plate 160 and the engagement means 148.

The rib portion 142a formed on the track member 142 also acts as an additional stop member to prevent the sliding member 144 disengaging from the track member 142.

The window unit 30 may be of any suitable construction, for example UPVC or timber or steel or alloy. The fixing bracket 40 may be any suitable material, for example stainless steel or galvanised steel.

The invention reduces the amount of manual handling of windows and doors on construction sites. The invention allows windows and doors to be installed within the structure of a timber frame panel kit under factory conditions during manufacture of the panels, and subsequently transported to site as part of the panels. Once the kit of panels has been erected on site, the window unit can be quickly installed in the final fixed position by sliding the entire window unit outwards. It is not necessary to wait for windows and doors to be installed before the building is weathertight, so that internal finishing works can start quickly. The provision of detent means 70, 72 in the fixing bracket 40 enables the window unit 30 to be moved to its final fixed position easily without additional onsite measurement.

1. A timber frame panel comprising a plurality of framing members which form a perimeter of a window opening, wherein at least one of the framing members has guidance means provided thereon, and wherein the timber frame panel includes a window unit slidably attached to said at least one of the framing members by said guidance means such that the entire window unit can move from a first position substantially within the timber frame panel to a second position in which part of the window unit projects beyond the timber frame panel.

2. A timber frame panel according to claim 1, wherein at least two of said framing members have guidance means provided thereon, and wherein the window unit is slidably attached to said at least two framing members by said guidance means.

3. A timber frame panel according to claim 1, wherein the guidance means is adapted to guide the window unit to move perpendicularly to the pane of the timber frame panel.

4. A timber frame panel according to claim 1, wherein the guidance means comprises a track member and a sliding member which engages with said track.

5. A timber frame panel according to claim 4, wherein the track member is attached to the framing member and the sliding member is attached to the window unit.

6. A timber frame panel according to claim 4, wherein the sliding member includes an arm which projects beyond the window unit and which is adapted to be fixed to the framing member when the window unit is in its second position.

7. A timber frame panel according to claim 6, wherein the track member includes a face plate secured to surface of the framing member parallel to the plane of the timber frame panel.

8. A timber frame panel according to claim 6, wherein the arm of the sliding member is adapted to slide within a slotted track formed in the track member.

9. A timber frame panel according to claim 4, further including first fixing means to fix the window unit in its first position.

10. A timber frame panel according to claim 9, wherein the first fixing means comprises coincident apertures in the track member and sliding member and a fastener passing through the apertures into the framing member.

11. A timber frame panel according to claim 4, further including second fixing means to fix the window unit in its second position.

12. A timber frame panel according to claim 11, wherein the second fixing means comprises coincident apertures in the track member and sliding member and a fastener passing through the apertures into the framing member.

13. A timber frame panel according to claim 4, wherein the track member and sliding member include mutually engaging detent means to prevent their relative movement beyond a position in which the window unit is in its second position.

14. A timber frame panel according to claim 13, wherein the detent means comprises a constriction in the track member and a shoulder in the sliding member adapted to bear against the constriction when the window unit is in its second position.

15. A timber frame panel according to claim 4, wherein the sliding member is attached to the window unit by lugs which engage with a slot in the window unit.

16. A timber frame panel according to claim 1, wherein four framing members form the perimeter of the opening, the framing members including two horizontal framing members and two vertical framing members.

17. A timber frame panel kit comprising a plurality of timber frame panels, at least one panel being a panel according to any preceding claim.

18. A method of constructing a building using a timber frame panel comprising the steps of
manufacturing a timber frame panel which includes a plurality of framing members which form a perimeter of a window opening;
installing a window unit in the window opening such that the window unit is in a first position substantially within the timber frame panel; transporting the timber frame panel to a construction site; assembling the timber frame panel with other panels; and
sliding the entire window unit from the first position to a second position in which part of the window unit projects beyond an external face of the timber frame panel.

19. The method of claim 18, wherein before sliding the window unit at least one first fixing means is released to allow relative movement of the window unit and timber frame panel, and after sliding the window unit at least one second fixing means is secured to fix the window unit relative to the timber frame panel.

20. The method of claim 18, wherein the method includes the further steps of:
constructing an external skin separated from the external face of the timber panel by a cavity; and
sealing the window unit in its second position to the external skin.

21. The method of claim 18, wherein in the first and second positions of the window unit, the plane of the window unit remains substantially parallel to the plane of the timber frame panel.

22. The method of claim 18, wherein the timber frame panel is a timber frame panel comprising a plurality of framing members which form a perimeter of a window opening, wherein at least one of the framing members has guidance means provided thereon, and wherein the timber frame panel includes a window unit slidably attached to said at least one of the framing members by said guidance means such that the entire window unit can move from a first position substantially within the timber frame panel to a second position in which part of the window unit projects beyond the timber frame panel.
